(19) United States
(12) Patent Application Publication
(10) Pub. No.: US 2014/0021279 A1
(43) Pub. Date: Jan. 23, 2014

(54) HEAVY DUTY MILL

(71) Applicants: Stefan Rittler, Freienstein (CH); Stefan Berchten, Kloten (CH)

(72) Inventors: Stefan Rittler, Freienstein (CH); Stefan Berchten, Kloten (CH)

(73) Assignee: FLSmidth A/S, Valby (DK)

(21) Appl. No.: 14/009,352

(22) PCT Filed: Apr. 4, 2011
(86) PCT No.: PCT/CH2011/000070

§ 371 Date: Oct. 2, 2013

(51) Int. Cl. H02K 1/06; B02C 15/00; H02P 6/08; H02K 9/02; H02K 3/28; H02K 11/00

(52) U.S. Cl. CPC H02K 1/06; H02K 3/28; H02K 11/0015; H02P 6/08; H02K 9/02; B02C 15/006
USPC 241/117; 310/179; 310/198; 310/68 B; 318/400.26; 310/58

(57) ABSTRACT

In a drive arrangement for a heavy duty mill an electric motor with a high number of magnetic poles and a stator that is segmented into at least four stator segments is used. By providing one, more or all of the stator segments with a three phase winding system, a highly modular mill drive with a high power density and therefore reduced space requirements is provided.

### TECHNICAL FIELD

The invention relates to a drive arrangement for a heavy duty mill, including an electric motor with a rotor and a stator

### BACKGROUND ART

Heavy duty mills for crushing ground material such as for example ore, coal, cement or the like are often designed as bowl mills with a vertical axis and a power somewhere between some hundred kW (kilo Watt) up to some MW (Mega Watt). Such bowl mills typically include a horizontally arranged bowl for retaining the material to be ground and a certain number of rollers where the bowl and the rollers are rotated in respect of each other, thereby crushing the material. Generally, the rollers are stationary whereas the bowl is rotated about the vertical mill axis. Such mills typically include a drive with an electric motor that drives the rotating element. Often, a gearing is arranged between the motor and the rotating element in order to reduce the drive speed to the desired value depending among other things on the material to be ground.

Such drives are typically designed for a given power range. Accordingly, a different drive has to be designed for a different application, for example an application with a smaller or larger mill or for a different material requiring a different output power.

Document WO 2008/049545 A1 (Gebr. Pfeiffer AG) discloses another solution for providing a scalable drive system for roller mills in a high power range up to ten Megawatts. In order to ensure a continuous availability of the mill, it is suggested to provide at least three drives where two of them are capable of achieving the full grinding capacity of the mill. But it is also possible to switch off or decouple one or more drives if the required grinding power is lower than the maximum grinding power of the mill Each drive is fed with electrical energy by an upstream frequency converter and includes a drive motor and a reduction gear. In one example, the motors are mounted with a horizontal axis and a bevel gear to connect it to a crown gear mounted on the mill In another example the motors are mounted with a vertical axis in cavities distributed around the mill and having a spur gear for driving the mill..

These drives require large motors and gears resulting in very high space requirements.

Another problem with heavy duty mills are torque variations induced by the grinding process.

Such torque variations may result in undesired resonances and therewith undesired loads or load peaks in the drive path. They may finally result in a reduced functionality, higher power consumption or even damage of the mill or the drive.

### SUMMARY OF THE INVENTION

Accordingly, it is a main object of the invention to create a drive arrangement for a heavy duty mill pertaining to the technical field initially mentioned, that avoids the above problems and enables the provision of a space efficient mill drive that may be used in many different applications. It is a further main object of the invention to create a heavy duty mill with such a drive arrangement.

The solution of the first mentioned main object of invention is specified by the features of claim 1. A drive arrangement for a heavy duty mill includes an electric motor with a rotor and a stator. Such heavy duty mills are used for crushing ground material such as for example ore, coal, cement or the like. According to the invention the number of magnetic poles of the rotor is at least eight and the stator is segmented into at least four stator segments, where each stator segment has at least two winding areas and where a winding is provided in each winding area of at least one stator segment.

Accordingly, by equipping the winding areas of a variable number of stator segments with a winding, the motor may provide a highly variable output power such that one and the same motor may be used in different applications just by varying the number of stator segments equipped with windings.

By providing each winding area of each stator segment with a winding, the motor may provide its full power. If the winding areas of only a part of the stator segments hold a winding the power that can be supplied by the motor is reduced but the motor does work. If the stator for example includes exactly four stator segments and each winding area of all stator segments are provided with a winding the motor provides four times the output power of the same motor where the winding areas of only one stator segment is equipped with a winding.

Since the power density of an electric motor rises with the number of poles, the power density of the motor according to the inventive drive arrangement is high, which means that the motor may be constructed with relatively low space requirements.

The motor is preferably a synchronous motor. Such motors require an excitation field which may for example be provided by excitation windings. It is however preferred to provide the rotor with permanent magnets which do not require any excitation power during operation.

In order to further raise the power density it is therefore advantageous to provide a rotor with a number of poles that is higher than eight such as for example 10, 12, 14, . . . , 24, 26, 28 or even higher. The stator then preferably includes a number of stator segments that corresponds to half the number of magnetic poles of the rotor. The diameter and the manufacturing costs of the motor however increase with an increasing number of magnetic poles. It has been found that a good compromise can be achieved in a preferred embodiment of the invention, wherein the number of magnetic poles of the rotor is twenty and where the stator includes exactly ten stator segments.

The number of winding areas and therewith the number of windings of a single stator segment can vary. It is in general possible to produce a rotating magnetic field with at least two phase shifted voltages. The number of windings of a single stator segment is therefore two or any number higher than two. Since three phase power supply systems are widely used, each stator segment preferably is implemented as a three phase system, including exactly three windings areas for holding a winding. In operation, these three windings are fed with three AC voltages each of them being phase shifted by plus or minus 120 degrees against the others. With three windings per stator segment, the above mentioned preferred embodiment with ten stator segments results in 30 winding areas and 20 magnetic poles.

The above mentioned winding areas of a stator are often called teeth because a stator with such winding areas does look similar to a gear wheel with its teeth. Accordingly, the windings are called single tooth windings and with three teeth per stator segment and ten stator segments the motor includes 30 single tooth windings and 20 magnetic poles.

Whereas the three windings of a stator segment may be delta connected they are preferably star connected in order to avoid an unbalanced power sharing within the three windings.

The motor typically includes a motor housing where the motor is positioned inside and the power source for feeding the motor is typically provided outside of the housing. Accordingly, the connections from the power source to the motor windings have to be lead through the motor housing.

There exist different possibilities to connect the windings in a star connection. It is for example possible to connect the three windings of a stator segment such that the star point is located inside the motor housing. The remaining end of each winding has then to be lead through an opening to the outside of the motor housing to connect them to the power source. However, leading these winding ends through different openings in the housing results in eddy currents around each opening. In order to minimise these power losses all three ends of the windings have to be lead to the outside of the housing through one and the same opening. Since there is no space left within the housing to lead all three winding ends to a common, small opening, a large opening for example in the form of an elongate slot spanning all three windings of a stator segment would have to be provided.

In order to avoid such large openings in the motor housing, the windings of a stator segment are preferably star connected such that the star point is positioned outside the motor housing. For this purpose both ends of each winding have to be lead to the outside of the motor housing. Again, in order to minimise the losses within the motor housing, both ends of each winding are preferably lead to the outside of the housing through one and the same opening and directly side by side. On the outside of the motor housing one end of each winding is connected to the star point and the other end of each winding is connected to the power source.

In order to identify the current angle between the rotor and the stator during operation of the electric motor, the motor includes in a preferred embodiment of the invention a measuring unit for determining an angular position of the rotor. Such measuring units include for example an absolute or incremental rotary encoder, a rotary variable differential transformer or other known devices.

Since the motor has to be controlled fast and precise, the electric motor preferably includes a resolver for the determination of the angular position of the rotor. In order to achieve redundancy, the motor includes at least two, preferably exactly two redundantly arranged resolvers, which means that the resolvers are electrically independent from each other. Accordingly, if the power supply for one resolver fails, the at least one other resolver continues to work properly.

It is generally possible to directly connect an electric motor to a multi-phase power supply network or a transformer. This results however in an unregulated motor with a more or less constant rotational speed that depends on the network frequency and other parameters such as the number of magnetic poles. Also, the output torque of the motor may not be controlled or at least not fast and precise enough or only in a small range.

In order to achieve a highly controllable electric motor, the drive arrangement preferably includes at least one frequency converter for feeding the stator windings. A frequency converter is fed with an AC current of a certain frequency and amplitude and generates there from an AC current with a controllable frequency and amplitude. This is achieved as widely known by means of a PWM (pulse width modulation) controller.

In order to achieve the required motor power, a frequency converter is preferably connected to the windings of at most two stator segments. Accordingly, if the stator is provided with more than two stator segments, the drive arrangement includes at least a second frequency converter.

In order to improve the controllability of the motor, that is a fast and precise control, the switching frequency of the frequency converter has to be high. In a preferred embodiment of the invention, a frequency converter with a switching frequency above 1 kHz is used. In a particularly preferred embodiment of the invention, the frequency converter has a switching frequency of about 4 kHz such that a very fast motor control may be realised.

Since a frequency converter for driving a heavy duty mill is typically operated with a medium voltage in the range from 3 kV to 30 kV, it is advantageous and therefore preferred to operate the frequency converters with a low voltage, that is an input voltage lower than 2 kV. In order to further reduce switching losses and temperature issues, the input voltage is preferably below 1 kV. The input voltage is for example in the range of 600 V to 800 V.

The output of a frequency converter is a three phase AC voltage preferably with a frequency from 0 Hz to about 300 Hz and amplitude between 0 V and the input voltage. A maximum frequency of about 200 Hz of the output voltage is even more preferred. When connected to the stator windings a rotating field with the frequency of the converter output voltage is generated. Together with the high number of magnetic poles, a high frequency of the rotating magnetic field in the motor further improves the power density of the motor, which results in an even more reduced material and therewith space requirement.

The motor concept described above results in a motor with high impedance. The effect of high impedance together with the high frequency of the rotating magnetic field in the motor is that the motor windings do not burn if a short circuit occurs at the output stage of the frequency converter or in the cables from the converter to the motor. Whereas power switches are generally positioned between the converter output stage and the motor to prevent such motor damage, these switches do not have to be used here. In a preferred embodiment of the invention, the output stage of each frequency converter is therefore connected to the electric motor by a direct, switchless electrical connection. In this way, not only the costs but once again the required space of the drive can be reduced.

As already mentioned above, with a frequency converter it is possible to control the amplitude and the frequency of its output voltage and the motor torque mainly depends on the voltage applied to its windings. It is therefore possible to control the motor torque by varying the frequency converter output voltage. To control its output voltage, each frequency converter includes a controller (typically the above mentioned PWM controller).

In order to enable a good motor torque regulation, the frequency converter needs to be provided with measuring data regarding the current torque requirements. Different possibilities exist to provide this data such as for example a torque sensor arranged on the motor shaft or other appropriate means. Preferably, the electric motor includes however at least one current measurement device for measuring a current in at least one motor winding where the measured current value is fed back to the controller of the frequency converter.

Due to the high switching frequency of 4 kHz of the frequency converter it is possible to achieve extremely short response times for the torque adjustment. An adjustment of the current to the required motor output torque from detection to realisation is achievable under 150 ms.

In a drive arrangement according to a preferred embodiment of the invention each frequency converter is completely DC-isolated from the ground, such that no current can flow back to the frequency converters through the motor bearings. This avoids damage of the bearings. This is achieved by a good isolation of the frequency converters and due to the fact that they are operated with a low voltage.

Depending on the voltage and frequency of the power supply network it is principally possible to directly connect the frequency converters to the supply network.

However, since the frequency converters are operated with a low input voltage and since a power supply network that is able to provide a power in the ten MW range typically is a medium voltage network, the drive arrangement according to a preferred embodiment of the invention includes at least one transformer unit to transform the medium voltage of the network to the low voltage required as an input to the frequency converters.

Depending on the output power of the used frequency converters, one, two or more frequency converters can be connected to a single transformer unit. In order to achieve redundancy, preferably only one or two frequency converters are connected to a single transformer unit. If more output power and therefore more than two frequency converters are required, further transformer units are provided.

Whereas the frequency converters can be connected directly to a transformer unit output, it is advantageous to connect them to a transformer unit via an inductor, a so called choke. This serves to reduce the system perturbation as well as the higher harmonics.

In order to further reduce the system perturbation as well as the higher harmonics, the transformer unit is preferably an at least twelve pulse transformer unit. Instead of providing a single twelve pulse transformer, the twelve pulse transformer unit includes in a preferred embodiment of the invention two six pulse phase shifted single transformers. A 18 pulse transformer unit is for example achieved by providing three six pulse phase shifted single transformers and a 24 pulse transformer unit is for example achieved by providing four six pulse phase shifted single transformers.

In an even more preferred embodiment of the invention, the transformer unit is a 30 pulse transformer unit that includes five phase shifted six pulse single transformers that are phase shifted by 12°.

A drive motor in a power class from several 100 kW up to 10 MW produces a lot of heat. In order to cool the motor any known cooling method may be employed. Such cooling methods include for example an air or liquid cooling of the motor housing. Additionally, in a preferred embodiment of the invention, a ventilating device is mounted on the rotor for producing an air circulation within the housing of the motor. Particularly the air circulates from the air gap between the rotor and the stator and the space between the stator and the housing of the motor. Preferably, a fan wheel is mounted on the upper side of the rotor coaxially with the rotor axis such that it rotates synchronously with the rotor and produces an upward air flow by drawing hot air from the air gap between the permanent magnets of the rotor and the stator windings.

Since the motor housing is substantially closed, the hot air is forced back to the bottom of the housing by pressing it through the space between the stator and the motor housing.

The solution of the other main object of the invention is specified by the features of claim 13. The drive arrangement described above is designed for driving a heavy duty mill such as for example a bowl mill (also called roll or roller mill) for crushing ground material such as for example ore, coal, cement or the like. According to the invention, the bowl mill includes a drive arrangement as described hereinbefore.

As mentioned above, due to the high number of magnetic poles and the high frequency of the rotating field the electric motor features a high power density which enables the provision of a compact motor with a relatively small diameter and therefore low space requirements. Furthermore, the whole drive arrangement is highly modular which means that it can be adapted very easily to a given application such as a given size or output power of the mill Particularly, by providing the desired number of stator segments with windings, providing the required input power by providing a corresponding number of frequency converters and by providing the required supply power by providing the required number of transformer units, the resulting output power of the motor can be varied in a wide range with only one single motor.

In a preferred embodiment, the bowl mill therefore includes exactly one drive arrangement as described hereinbefore. Unlike in the above mentioned document WO 2008/049545 A1 the modularity of the drive arrangement is achieved by the specific design of the motor.

In addition, the length of the motor can be varied too. The motor length mainly depends on the length of the windings carried by the teeth of the stator segments. By providing for example two different types of stator segments such as for example a first type of a certain length and a second type of twice the length of the first type (and adapting the length of the other parts of the motor accordingly), it is possible to provide a drive system for heavy duty mills with an extremely wide power range all having the same motor diameter.

Due to the very low space requirements of the drive motor, the motor can be arranged beneath the mill In a preferred embodiment of the invention, the bowl mill is therefore a vertical bowl with a (substantially) vertical mill axis and where an axis of the bowl mill and an axis of the electric motor of the drive arrangement are arranged in parallel.

In order to reduce the effort for connecting the motor to the mill, their axes are preferably arranged coaxially. By arranging the mill and the motor in parallel instead of perpendicular as in most known heavy duty mills, there is no need to provide a bevel gear requiring a lot of space.

A heavy duty mill typically includes a rotating and a stationary element. Typically and preferably the rotating element includes the bowl. The bowl therefore rotates about the mill axis and the rollers are stationary which means they do not rotate around the mill axis but the typically do rotate around their own rotation axis when rolling on the bowl. It is however possible that the rotating element includes the rollers and that the bowl is stationary or that the bowl as well as the rollers rotates about the mill axis.

Although the rotating element of the mill may be directly connected to the motor shaft it is preferred that the bowl mill includes a gearing arranged between the electric motor and the rotating element. Since the rotation speed of the motor is rather high, for example in the range of several hundred to several thousand rounds per minute, the gearing preferably reduces the rotational speed to a value reasonable for the particular application, typically in the range of several rounds per minute to several dozens of rounds per minute.

Generally every kind of high torque transmission gear may be used to connect the motor to the mill However, gear mechanisms with gear wheels are widely used and therefore preferably used.

Planetary gears are however the most preferred kind of gearing for such mills because they can be realised rather compactly. Furthermore, planetary gears can transmit high torques because the torque is distributed to the plurality of planets.

Another advantage of a planetary gear is that they can be combined together with the motor to form a compact motor/gearing unit with low space requirements and that can be integrated into the bowl mill.

The gearing may for example include a single stage or a multi-stage planetary gearing. To best meet the torque, space and cost requirements, the gearing preferably includes exactly two planetary stages.

The drive arrangement and/or the mill may include further components such as for example components for cooling, lubrication, higher level controls and others. Since such components are not affected by the invention, they are not further described.

Unless otherwise stated or becomes clear from the circumstances, each of the above and below described features of a mill drive and the mill are applicable on their own and in addition to each other.

Other advantageous embodiments and combinations of features come out from the detailed description below and the totality of the claims.

### BRIEF DESCRIPTION OF THE DRAWINGS

The drawings used to explain the embodiments show:

FIG. 1 a schematic diagram of heavy duty bowl mill according to the invention connected to a medium voltage power supply network;

FIG. 2 a schematic diagram of a sectional view of a drive motor and integrated planetary gear;

FIG. 3 a schematic diagram of a sectional view of the electric motor;

FIG. 4 a schematic diagram of a single stator segment provided with three windings;

FIG. 5 a schematic wiring diagram of a stator segment holding three star connected windings;

FIG. 6a)-c) schematic diagrams of stators with different numbers of stator segments holding windings and

FIG. 7 a schematic diagram of a first example of a drive arrangement according to the invention and

FIG. 8 a schematic diagram of another example of a drive arrangement according to the invention.

In the figures, the same components are given the same reference symbols.

Preferred Embodiments

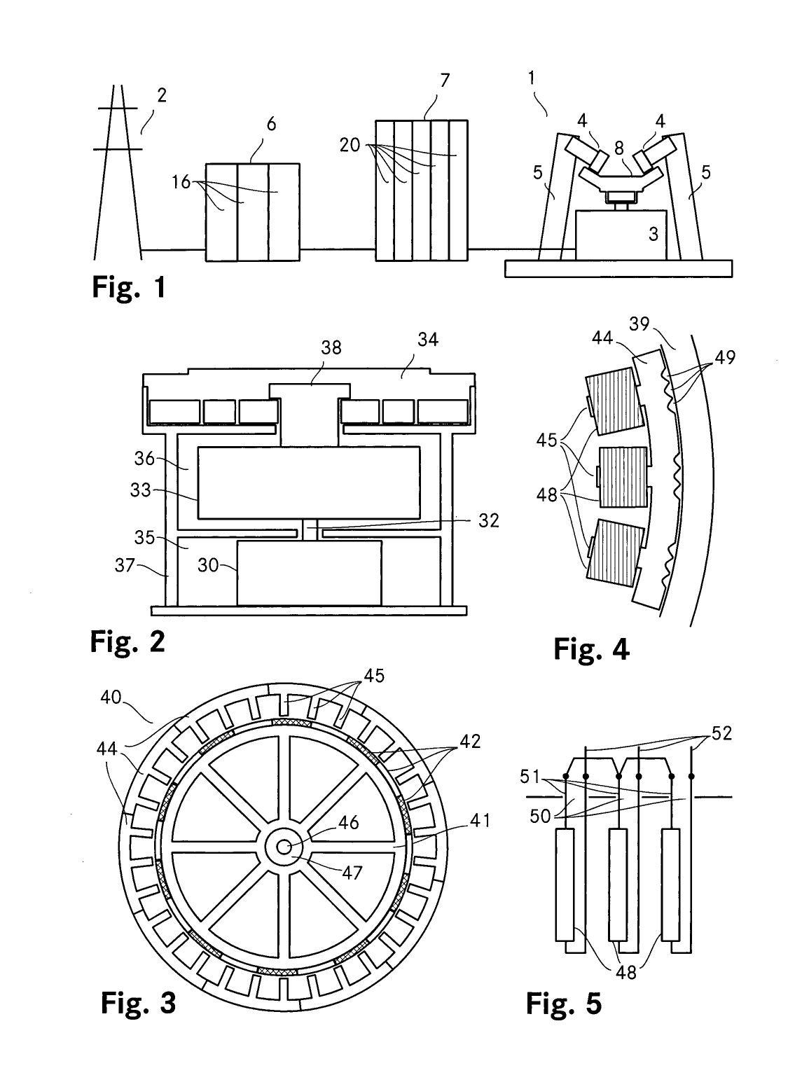

FIG. 1 shows a exemplary, schematic diagram of a heavy duty bowl mill 1 connected to a medium voltage power supply network 2. The mill 1 is a vertical mill with a motor/gear unit 3 and a bowl 8 that is driven by the motor/gear unit 3. The mill 1 further includes a pair of rollers 4 mounted on stationary rests 5 but pivoted about a horizontal axis. The motor/gear unit 3 is positioned coaxially beneath the mill 1.

A transformer arrangement 6 with up to five transformers 16 is connected to the medium voltage power supply network 2. Each transformer 16 transforms the medium voltage of the power supply network 2 in the range of 3 to 16 kV and 50 Hz or 60 Hr, into a low voltage of 690 V with a frequency of 50 Hz or 60 Hz. On the other side the transformer arrangement 6 is connected to a frequency converter array 7 with up to ten frequency converters 20. Each transformer 16 is connected to the frequency converter array 7 via a choke (not shown) in order to reduce the system perturbation and the higher harmonics.

Each frequency converter 20 transforms the 690 V/50 Hz or 60 Hz input voltage into a variable and controllable voltage from 0 V to 690 V and a frequency from 0 Hz to 200 Hz for operation of the mill 1. Each converter 20 has a continuous power of about 800 kW and since all converters 20 are the same they be exchanged amongst each other if needed. One of the converters 20 serves as a master and a second converter 20 is defined as a second master in case the first master fails. At least one, preferably both master converters are connected to a speed sensor, which provides the speed signal that is used to control the output power of the converters. The other converters 20 are slaves and are controlled by the currently active master.

To achieve an output power of the motor of 8 MW, five transformers 16 are needed each with a power of 2 MW. Each of these five transformers shifts the phase current on the medium voltage side by 12 degrees. This results in a 30 pulse transformer design enabling a smooth load. It has been found that with such a 30 pulse transformer most of the higher harmonic distortions up to the 49^{th} order virtually disappear. Only some negligible distortions occur at the 29^{th} and the 31^{st} harmonic.

The transformers may be connected to the medium voltage supply network by means of a medium voltage switchgears that distributes the medium voltage on the transformers and that turns the whole system off in case of an over current on one of the transformers.

The motor is a synchronous permanent magnet motor with 20 poles with a resulting rotational speed of 1000 rounds per minute.

FIG. 2 shows a schematic diagram of a sectional view of an integrated drive with a motor 30 and a planetary gear 33. The drive is arranged in a drive housing 37, where the motor 30 is positioned in a lower compartment 35 of the drive housing 37 and the planetary gear 33 is positioned in an upper compartment 36 of the drive housing 37. The planetary gear 33 transmits the rotation of the motor shaft 32 into a rotation of the output flange 34 via a fixed coupling 38.

FIG. 3 shows a schematic diagram of a sectional view of the stator and the rotor of the electric motor 30. The motor 30 includes a motor housing (not shown), a stator 40 and an inner rotor 41. The stator 40 is fixed within the motor housing 39 which again is fixed within the drive housing 37. It is segmented into ten stator segments 44 forming together a circular stator 40. The rotor 41 has 20 poles in the form of permanent magnets 42 mounted on the outer circumference of the rotor 41. Each segment 44 has 3 teeth 45 for holding a winding of a three phase winding system. In FIG. 3 none of the teeth 45 holds windings.

The rotor 41 is for example made up of several rotor discs stacked coaxially upon each other (not shown). Each disc has twenty permanent magnets. The rotor 41 is rotatable about the motor axis 46 formed by the motor shaft 47.

The motor includes at least two resolvers (not shown) that are electrically independent of each other such that they are redundant. Each resolver includes an outer ring that is fixed in relation to the stator 40 and an inner ring that is fixed in relation to the rotor 41. The resolver works as a small rotary transformer and delivers a signal that is representative of the current angular position of the rotor in relation to the stator.

FIG. 4 shows a schematic diagram of a single stator segment 44 in more detail. All of the three teeth 45 of this stator segment 44 hold a winding 48 in the form of a single-tooth winding. The windings 48 are typically stranded conductors. The connections of the windings 48 to the frequency converter are schematically shown in FIG. 5.

The stator segment 44 is shown next to a section of the motor housing 39. For cooling purposes, the stator segment 44 includes several recesses 49 in the form of vertical grooves on the outer circumference of the segment 44. Within these recesses 49 hot air can circulate within the motor housing 39 where the housing 39 itself forms a heat sink. Alternatively or in addition, such recesses may also be provided on the inner surface of the motor housing 39.

The drive may be provided with different overall lengths. The length determining parts are the stator windings. In a short drive the stator windings have for example a length of about 400 mm and in a long drive they have for example the double length, which is about 800 mm The other parts of the motor have to be adapted accordingly. The length of the rotor can be adapted very easily just by providing a higher or lower number of rotor discs. In this way, the output power of the drive can be varied in addition to varying the number of stator segments provided with windings.

FIG. 5 shows a schematic wiring diagram of the three windings 48 of a stator segment 44. The windings 48 are arranged on the inside of the motor housing 39 which has three holes 50 where each hole 50 is provided next to one of the windings 48. Both ends 51, 52 of each winding 48 are fed through the same hole 50 lying next to the winding 48 to the outside of the motor housing 39. On the outside of the housing 39 the windings 48 are star connected by connecting the ends 51 of each winding 48 together such that the star point lies outside of the housing 39. The other ends 52 of each winding 48 are connected to a frequency converter (not shown in FIG. 5).

Since the motor produces heat during operation and oil is used for lubrication and cooling, the cables used to connect the frequency converters to the motor (at least those parts that are directly connected to the motor) preferably have an oil compatible and heat resistant isolation such as for example PTFE (Teflon).

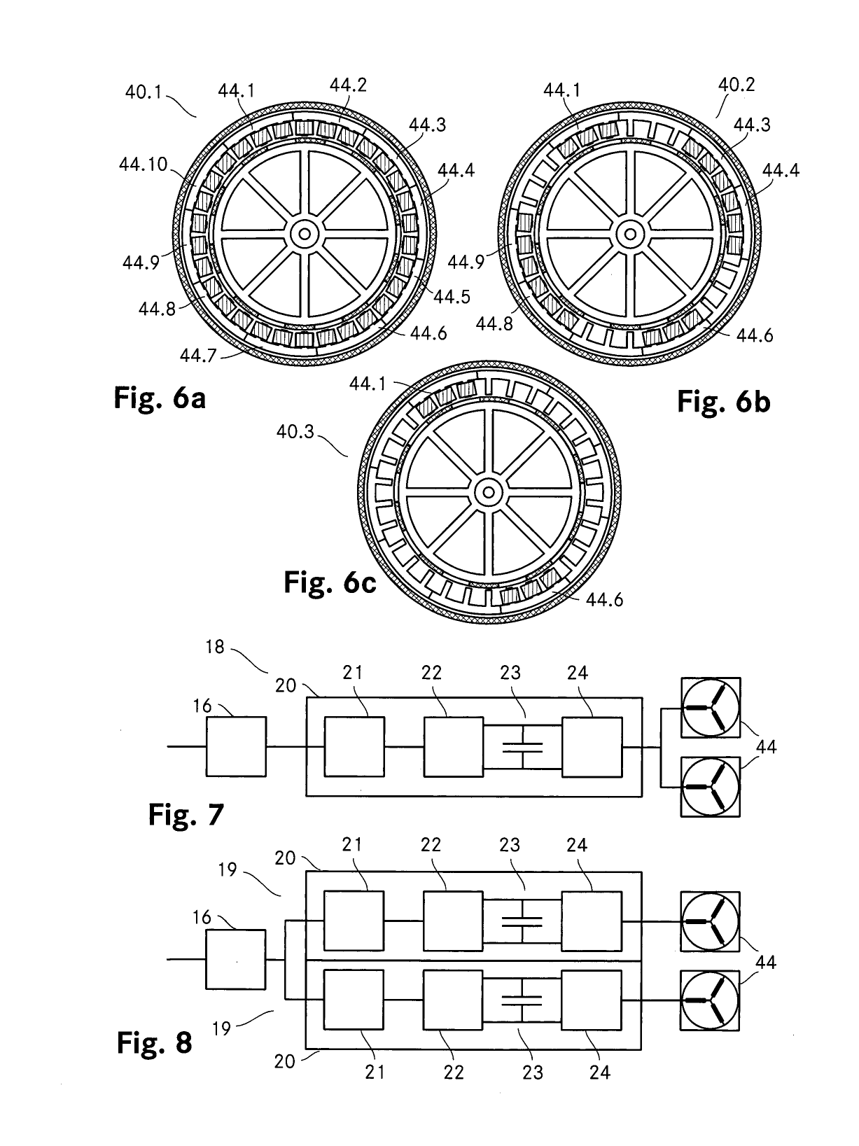

FIGS. 6a) to 6c) show schematic diagrams of stators 40.1, 40.2, 40.3 with different numbers of stator segments holding windings. FIG. 6a) shows a stator 40.1 where the teeth of all ten stator segments 44.1, 44.2 . . . 44.10 are provided with windings. A motor with such a stator can provide its full power. FIG. 6b) shows a stator 40.2 where the teeth of only six stator segments 44.1, 44.3, 44.4, 44.6, 44.8 and 44.9 are provided with windings. A motor with such a stator can only provide three fifth of the power of a motor with a fully equipped stator (assumed that nothing else is changed). FIG. 6c) shows a stator 40.3 where the teeth of only two stator segments 44.1 and 44.6 are provided with windings. A motor with such a stator can only provide one fifth of the power of a motor with a fully equipped stator (assumed that nothing else is changed).

If some of the stator segments 44 are not equipped with windings or if they are equipped with windings but not operated, that is not supplied with power, it is preferred that opposing segments 44 are not equipped with windings or not operated in order to balance the forces that act upon the motor bearings.

It is generally possible to provide only one of the segments 44 with windings (but not the opposing one). A motor with such a stator will work too and due to the relatively low motor power the unbalanced forces on the bearings are relatively small. But such a configuration is normally not used.

FIG. 7 shows a schematic diagram of a first example of a drive arrangement according to the invention. In this example, one drive train 18 supplies exactly two stator segments 44 with electrical energy.

The drive train 18 includes a transformer 16 connected to a frequency converter 20 which feeds the two three phase stator segments 44. The frequency converter 20 includes an input stage 21 with input switches to connect or disconnect the converter 20, a rectifier stage 22 feeding a DC voltage intermediate circuit 23 (indicated as a capacity) followed by an output stage 24.

Although shown as single lines, it is clear for one skilled in the art that the connections between the transformer 16, the frequency converter 20 and the stator segments 44 are all three phase connections.

The transformer 16 has for example an input power of 2 MW and the frequency converter 20 consumes for example 800 kW. In the configuration shown where the single frequency converter 20 feeds two stator segments 44 these stator segments 44 are short segments consuming each only about 400 kW.

FIG. 8 shows a schematic diagram of another example of a drive arrangement according to the invention. In this example, two drive trains 19 supply exactly two stator segments 44 with electrical energy.

Again each drive train 19 includes a frequency converter 20 where each of them feeds exactly on three phase stator segment 44. Each frequency converter 20 is the same as the one shown in FIG. 7 and includes an input stage 21, a rectifier stage 22, a DC voltage intermediate circuit 23 and an output stage 24.

Contrary to the example shown in FIG. 7, both drive trains 19 are however fed by a single transformer 16. The transformer 16 has for example an input power of 2 MW and both frequency converters 20 again consume 800 kW. In this example the stator segments 44 are long segments consuming each about 800 kW.

Up to ten drive trains 19 can be operated in parallel to supply a fully equipped long motor (that is a motor with long stator segments). Such a configuration includes five transformers 16, each having two MW power for feeding the ten frequency converters 20 each having 800 kW. The motor therefore receives eight MW of power and may feed a fully equipped long stator with ten long stator segments in total, each having 800 kW power. Each of these drive trains 19 is operable on its own.

In this way the required redundancy is achieved and the drive arrangement can—even if one or more components fail—be further operated with an accordingly reduced power.

In summary, it is to be noted that the invention enables the provision of a small, highly modular drive for heavy duty mills in a power range up to ten or even more MW.

1. A drive arrangement for a heavy duty mill, including an electric motor with a rotor and a stator, characterised in that a number of magnetic poles of the rotor is at least eight and in that the stator is segmented into at least four stator segments each having at least two winding areas, where a winding is provided in each winding area of at least one stator segment.

2. A drive arrangement according to claim 1, where the number of magnetic poles of the rotor is twenty and the stator includes exactly ten stator segments.

3. A drive arrangement according to claim 1, where each stator segment has exactly three winding areas and where the windings provided in the winding areas of a stator segment are connected in a star circuit, where both ends of each winding are preferably lead to an outside of a housing of the motor through a single opening and where a star point of the star circuit is preferably positioned outside of the housing.

4. A drive arrangement according to claim 1, where the electric motor includes one, advantageously two or more redundantly arranged measuring units for determining an angular position of the rotor, where a measuring unit preferably includes a resolver.

5. A drive arrangement according to claim 1, including at least one frequency converter that is connected to the windings of a stator segment, where the at least one frequency converter is preferably connected to the windings of at most two stator segments.

6. A drive arrangement according to claim 5, where each frequency converter is operable with a switching frequency higher than 1 kHz, preferably with a switching frequency of about 4 kHz.

7. A drive arrangement according to claim 5, where each frequency converter is operable with an input voltage lower than 2000 Volts, preferably with an input voltage lower than 1000 Volts.

8. A drive arrangement according to claim 5, where an output stage of each frequency converter is connected to the electric motor by a direct, switchless electrical connection.

9. A drive arrangement according to claim 5, where the electric motor includes at least one current measurement device for measuring a current in at least one winding of a stator segment, and where each frequency converter includes a controller for controlling a torque of the electric motor in dependency of the measured current.

10. A drive arrangement according to claim 5, where each frequency converter is completely DC-isolated from ground.

11. A drive arrangement according to claim 10, including at least one transformer unit connected to exactly one or two of said frequency converters, where the at least one transformer unit preferably is connected to said one or two frequency converters via an inductor.

12. A drive arrangement according to claim 11, where said at least one transformer unit is at least a twelve pulse transformer unit, preferably a 30 pulse transformer unit that includes five phase shifted six pulse transformers.

13. A drive arrangement according to claim ,1 where a ventilating device is mounted on the rotor for circulating air within a housing of the motor from an air gap between the rotor and the stator and a space between the stator and the housing of the motor.

14. A heavy duty mill, particularly a bowl mill, with exactly one drive arrangement according to claims 1.

15. A heavy duty mill according to claim 14, where the bowl mill is a vertical bowl with a vertical mill axis and where an axis of the bowl mill and an axis of the electric motor of the drive arrangement are arranged in parallel, preferably coaxially.

16. A heavy duty mill according claim 14, where the bowl mill includes a rotating element and a gearing arranged between the electric motor and the rotating element, where the rotating element preferably includes the bowl.

17. A heavy duty mill according to claim 16, where the gearing includes at least one planetary stage, preferably exactly two planetary stages.
